(19) United States
(12) Patent Application Publication
(10) Pub. No.: US 2004/0211810 A1
(43) Pub. Date: Oct. 28, 2004

(54) Cartridge for a nail driving device

(75) Inventors: Kuo-Hsiung Ho, Nan-Tou Hsien (TW); Jung-Yu Wang, Taichung-Hsien (TW)

Correspondence Address: LOWE HAUPTMAN GILMAN & BERNER LLP, Suite 310, 1700 Diagonal Road, Alexandria, VA, 22314, US

(73) Assignee: MOBILETRON ELECTRONICS CO., LTD.

(21) Appl. No.: 10/610,793

(22) Filed: Jul. 2, 2003

(30) Foreign Application Priority Data
Apr. 25, 2003 (TW) 092206626

(51) Int. Cl. B25C 5/02

(52) U.S. Cl. 227/120

(57) ABSTRACT

A cartridge for a driving device includes a stationary part extending transversely from a nose plate, and a slidable part mounted slidably on cooperating with the stationary part to define a nail-receiving channel which has an inverted U-shaped portion and a straight branch portion. The U-shaped portion has a bight segment and opposing segments extending downwardly and respectively from two opposite ends of the bight segment toward a discharging end of the nose plate. The straight branch portion extends upwardly from one of the opposite ends of the bight segment in the vertical direction.

### BACKGROUND OF THE INVENTION

1. Field of the Invention

The invention relates to a cartridge, more particularly to a cartridge for a nail driving device.

2. Description of the Related Art

Referring to FIGS. 1, 2 and 3, a conventional cartridge is shown to be mounted to a barrel unit 11 of a pneumatic nail driving device 10, and includes a nose plate 13, a cover plate 17, and a nail-holding member 12. The nose plate 13 has opposite front and rear faces, and extends in a vertical direction from the barrel unit 11 of the driving device 10. The cover plate 17 is mounted on the front face of the nose plate 13 to define a nail-impelling track 170 therebetween, and is coupled to the barrel unit 11 through a fastening device 135 such that the nail-impelling track 170 is in alignment with the barrel unit 11. The nose plate 13 has a discharging end 13″ distal from the barrel unit 11 and a coupling end 13′ proximate to the barrel unit 11, and is formed with a U-shaped nail passage 130 that extends through the front and rear faces of the nose plate 13 and that is in spatial communication with the nail-impelling track 170. The nail passage 130 of the nose plate 13 includes a bight segment 131 adjacent to the coupling end 13′ of the nose plate 13, and opposing left and right segments 132,133 extending respectively from two opposite ends of the bight segment 131 toward the discharging end 13″ of the nose plate 13. The nail-holding member 12 includes a slidable part 15, a stationary part 14 and an urging member 16. The stationary part 14 is secured to the nose plate 13, extends in a transverse direction relative to the nose plate 13, and has an elongated projection 14″. The slidable part 15 extends rearwardly from the rear face of the nose plate 13 in the transverse direction, and is slidable in the transverse direction. The slidable part 15 has a peripheral wall 150 that confines an inner space therein. The slidable part 15 is slidably mounted to the stationary part 14, in which the projection 14″ is received in the inner space and cooperates with the peripheral wall 150 of the slidable part 15 to define an inverted U-shaped nail-receiving channel 18 between the slidable and stationary parts 15,14. The nail-receiving channel 18 is in alignment with the nail passage 130 of the nose plate 13, and is adapted to receive a plurality of U-shaped nails 21 or a plurality of elongated nails 20. The nail-receiving channel 18 includes a bight section 181 and opposing left and right sections 182,183 which extend respectively from two opposite ends of the bight section 181. The left section 182 of the nail-receiving channel 18 serves as an elongated chamber for receiving the elongated nails 20 therein. The urging member 16 is disposed between the stationary and slidable parts 14,15 so as to feed one of the nails 20,21 from the nail-holding member 12 into the nail-impelling track 170 through the nail passage 130 of the nose plate 13. The nail 20(21) in the nail-impelling track 170 is discharged through the discharging end 13″ of the nose plate 13 upon actuation of a nail impelling unit (not shown) that is disposed in the barrel unit 11 of the nail driving device 10.

The conventional cartridge is disadvantageous in that since the bight section 181 of the nail-receiving channel 18 of the nail-holding member 12 is proximate to the barrel unit 11 of the nail driving device 10, distal ends 211 of left and right portions of an inverted U-shaped nail 21 will be relatively far apart from the discharging end 13″ of the nose plate 13 in case the size of the nail 21 is relatively small. Thus, during a nailing operation, the nail 21 needs to travel a relatively long distance before hitting an object (A), which will undesirably decrease the driving force of the nail 21.

### SUMMARY OF THE INVENTION

Therefore, the object of this invention is to provide a cartridge for a nail driving device which can overcome the aforementioned disadvantage of the conventional cartridge of the nail driving device.

Accordingly, a cartridge of the present invention is adapted to be connected to a nail driving device having a barrel and a plunger, and includes: a nose plate adapted to be connected to the barrel, extending in a vertical direction, having opposite front and rear faces and a discharging end distal from the barrel, and formed with a nail-discharging opening that is disposed adjacent to the discharging end and that extends through the front and rear faces, and a nail-impelling track that extends in the vertical direction, that is in spatial communication with the nail-discharging opening and that is adapted to receive the plunger; and a nail-holding member including a stationary part that is disposed rearwardly of and that is secured to the nose plate, that extends in a transverse direction relative to the nose plate, and that has a front end, and a slidable part that extends rearwardly from the rear face of the nose plate in the transverse direction, and that is slidable in the transverse direction, the slidable part having a peripheral wall that has opposite front and rear ends and that confines an inner space therein, the inner space extending from the front end to the rear end in the transverse direction, the slidable part being mounted slidably on the stationary part in such a manner that the stationary part is received in the inner space and cooperates with the peripheral wall of the slidable part to define a nail-receiving channel therebetween, and that the front end of the stationary part extends outwardly of the inner space into the nail-discharging opening in the nose plate. The nail-receiving channel is in spatial communication with the nail-discharging opening of the nose plate, extends rearwardly from the nail-discharging opening in the transverse direction, and is adapted to receive nails therein. The nail-receiving channel of the nail-holding member has an inverted U-shaped portion and a straight branch portion. The inverted U-shaped portion has a bight segment and opposing first and second segments extending downwardly and respectively from two opposite ends of the bight segment in the vertical direction. The straight branch portion extends upwardly from one of the opposite ends of the bight segment in the vertical direction.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a fragmentary perspective view of a conventional cartridge mounted on a nail driving device;

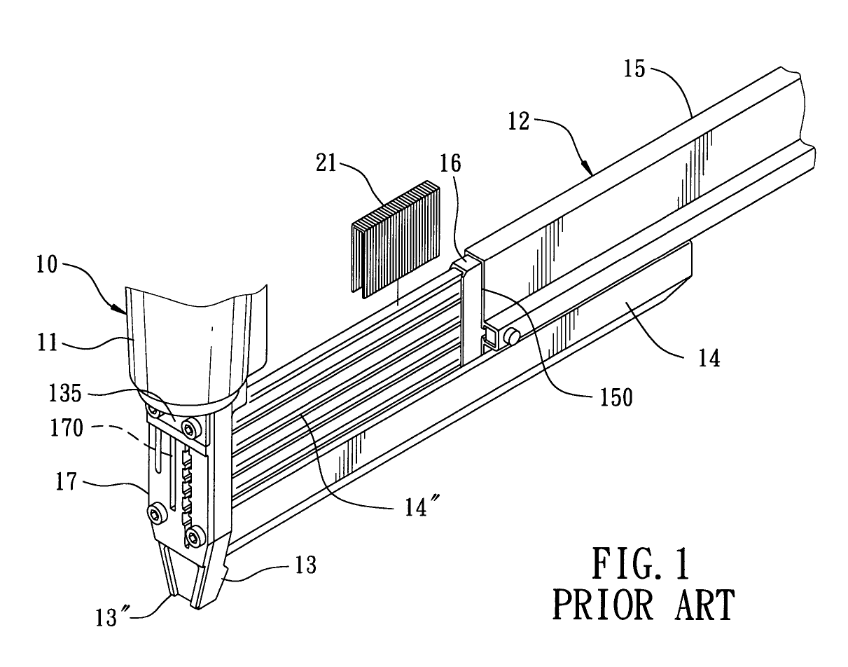

FIG. 2 is a schematic partly sectional view of the conventional cartridge, illustrating how an elongated nail is received in a nail-receiving channel of a nail-holding member;

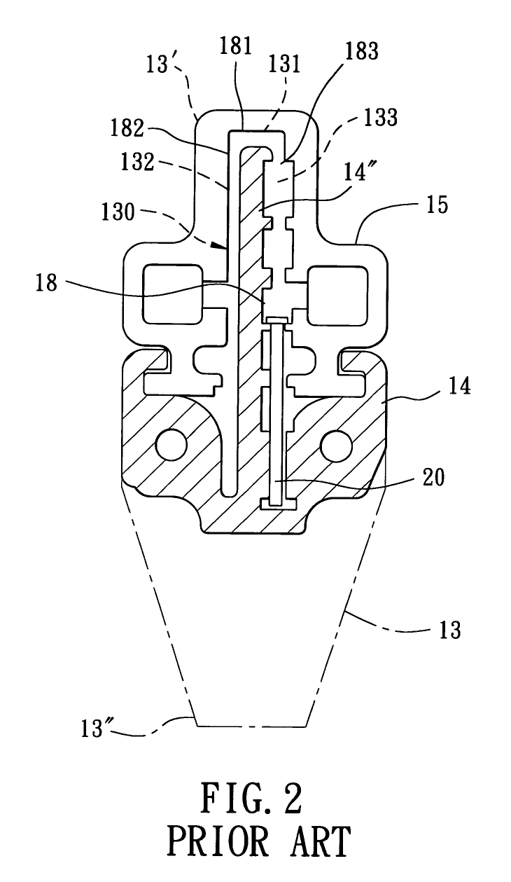

FIG. 3 is a schematic, partly sectional view of the conventional cartridge, illustrating how an inverted U-shaped nail is received in the nail-receiving channel of the nail-holding member;

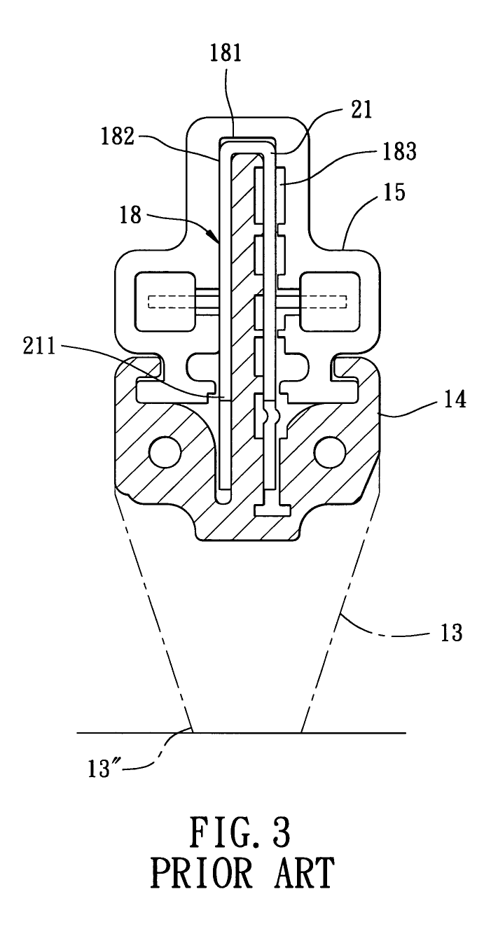

FIG. 4 is a side view of the preferred embodiment of a cartridge according to the present invention when mounted on a nail driving device;

FIG. 5 is an exploded perspective view of the preferred embodiment;

FIG. 6 is a side view of the preferred embodiment, with a nose plate removed to show how an elongated nail is received in a nail-receiving channel of a nail-holding member;

FIG. 7 is a side view of the preferred embodiment, with the nose plate removed to show how an inverted U-shaped nail is received in the nail-receiving channel of the nail-holding member; and

FIG. 8 is a fragmentary sectional view of the preferred embodiment when mounted on the nail driving device.

### DETAILED DESCRIPTION OF THE PREFERRED EMBODIMENT

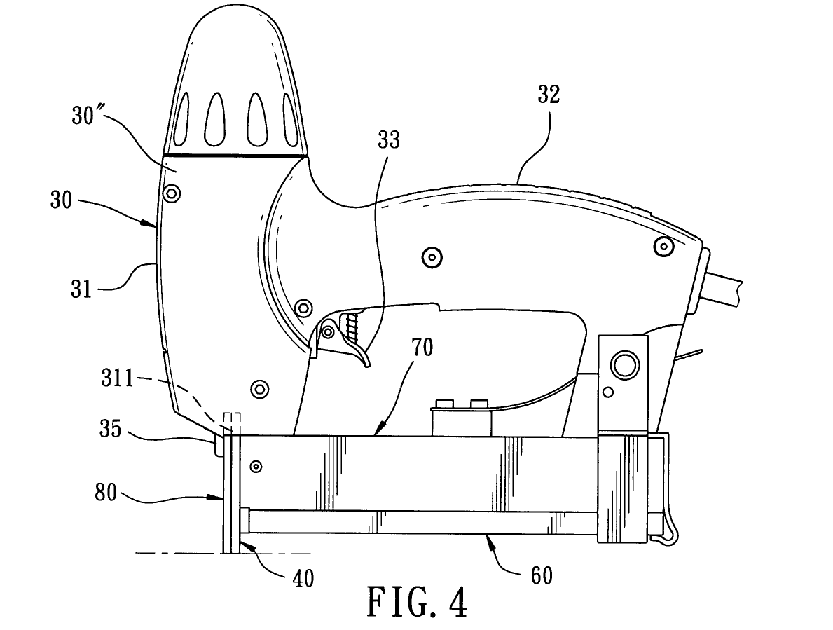

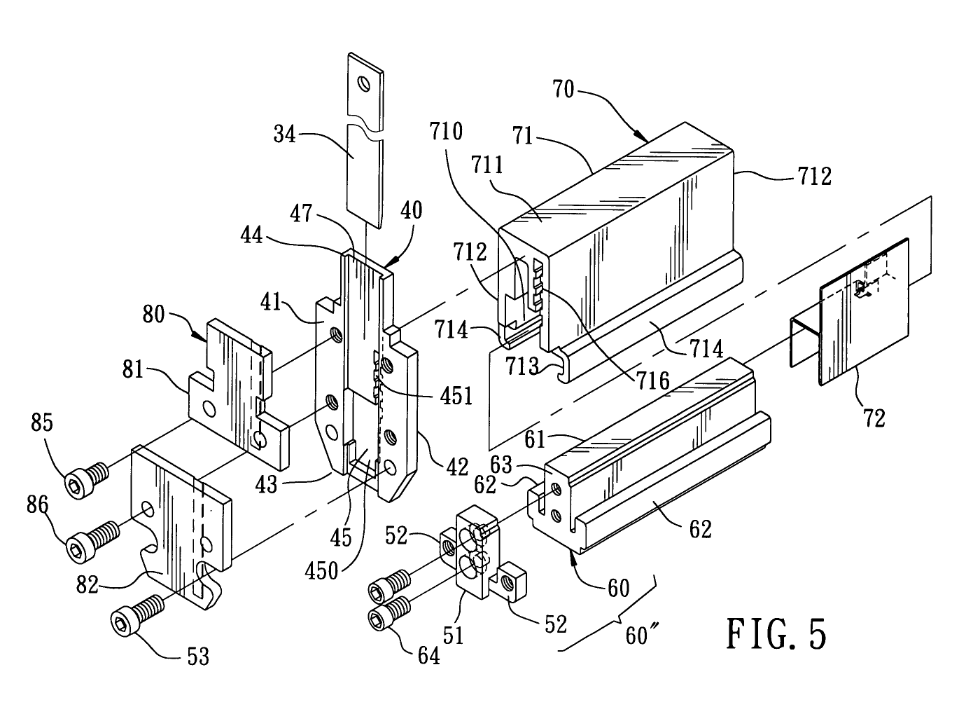

Referring to FIGS. 4 and 5, the preferred embodiment of a cartridge according to the present invention is shown to be installed on a barrel 31 of a nail driving device 30, and includes an elongated nose plate 40, an elongated cover plate 80, and a nail-holding member 70.

As illustrated, the driving device 30 includes a gun housing 30″, a handgrip portion 32 extending transversely from the gun housing 30″, and a nail impelling plunger 34 disposed in the gun housing 30″ and adapted to extend into a discharging path 311 of the barrel 31 upon actuation of a trigger 33 that is mounted on the gun housing 30″ and that is operably connected to the plunger 34. Since the feature of the present invention does not reside in the plunger 34 and the trigger 33, a detailed description of the same is omitted herein for the sake of brevity.

The nose plate 40 is adapted to be connected to the barrel 31 through a fastening device 35, extends in a vertical direction, has opposite front and rear faces 41,42, a discharging end 43 distal from the barrel 31, and a coupling end 44 opposite to the discharging end 43 and adapted to be connected to the barrel 31 of the nail driving device 30. The nose plate 40 is formed with a nail-discharging opening 45 that is disposed adjacent to the discharging end 43 and that extends through the front and rear faces 41,42, and a nail-impelling track 47 that extends in the vertical direction and that is in spatial communication with the nail-discharging opening 45 and that is adapted to receive the plunger 34. The nail-discharging opening 45 of the nose plate 40 has a rectangular portion 450 adjacent to the nail-discharging end 43 of the nose plate 40 and a straight branch portion 451 that extends upwardly from the rectangular portion 450 in the vertical direction.

The cover plate 80 includes a first plate half 81 mounted on the front face 41 of the noseplate 40 through two fastening screws 85 (only one is shown in FIG. 5) to cover the nail-impelling track 47, and a second plate half 82 mounted on the front face 41 of the nose plate 40 through two fastening screws 86 (only one is shown in FIG. 5) adjacent to the first plate half 81 to cover the nail-discharging opening 45 in the nose plate 40. The first and second plate halves 81,82 may be integrally formed.

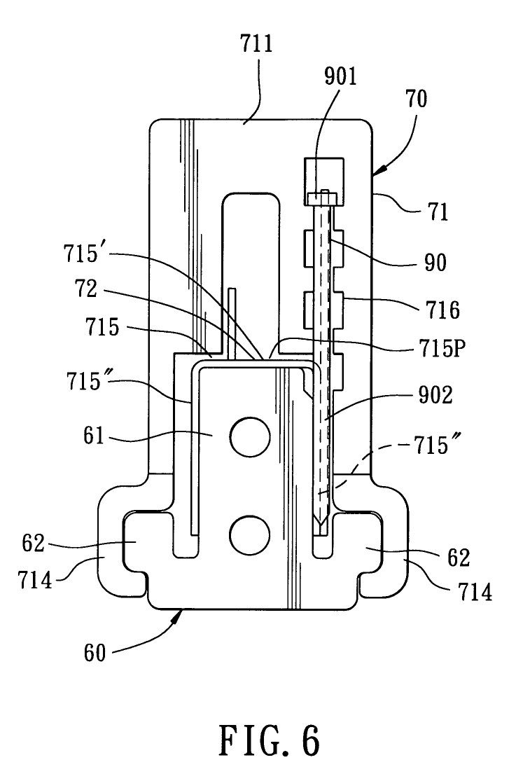

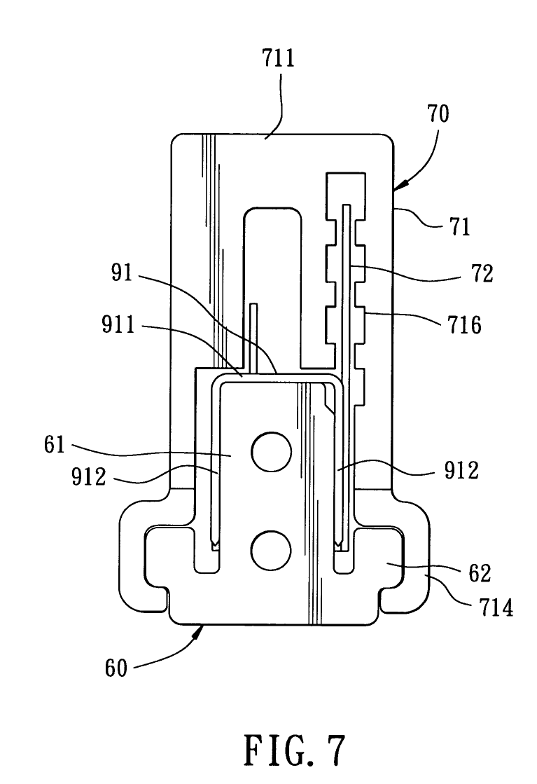

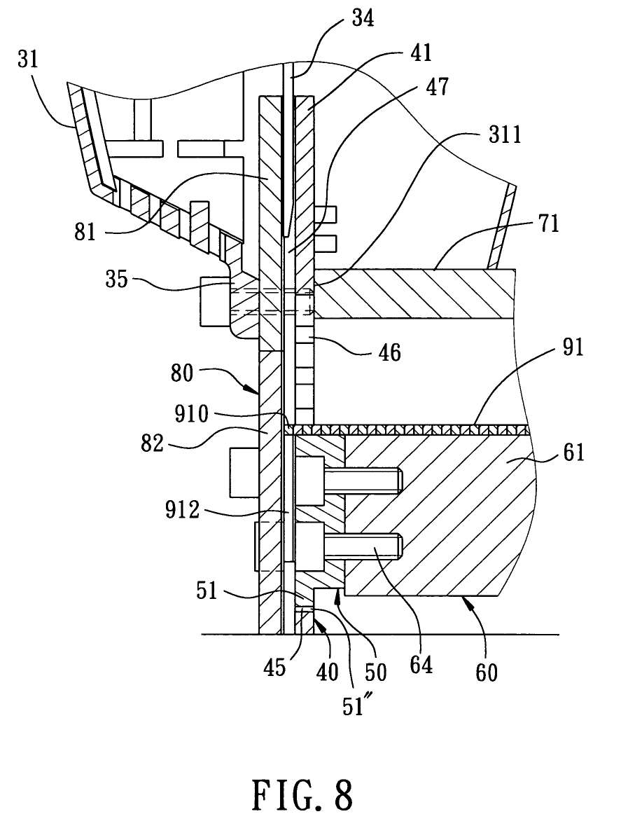

The nail-holding member 70 includes a stationary part 60″, a slidable part 71, and an urging member 72. The stationary part 60″ includes a block body 51 and an elongated base 60. The elongated base 60 is disposed rearwardly of and is mounted to the nose plate 40 through the block body 51, extends in the transverse direction, and has an elongated projection 61 projecting upwardly therefrom, and two elongated rails 62 projecting upwardly from two opposite sides of the elongated base 60. The slidable part 71 extends rearwardly from the rear face 42 of the nose plate 40 in the transverse direction, and is slidable in the transverse direction. The slidable part 71 includes a peripheral wall 711 that has opposite front and rear ends 712 and that confines an inner space 710 therein such that the inner space 710 extends from the front end 712 to the rear end 712 in the transverse direction. The peripheral wall 711 further has two elongated side wall portions 714 that respectively define two rail-receiving grooves 713 that are in spatial communication with the inner space 710. The slidable part 71 is mounted slidably on the elongated base 60, in which the rails 62 of the elongated base 60 are respectively received in the rail-receiving grooves 713, and in which the projection 61 is received in the inner space 710 to cooperate with the peripheral wall 711 to define a nail-receiving channel 715 (see FIG. 6) between the elongated base 60 and the slidable part 71. The nail-receiving channel 715 has an inverted U-shaped portion (715P) and a straight branch portion 716 (see FIG. 6). The inverted U-shaped portion 715P has a bight segment 715′ and opposing first and second segments 715″ extending downwardly and respectively from two opposite ends of the bight segment 715′ in the vertical direction. The straight branch portion 716 extends upwardly from one of the opposite ends of the bight segment 715′ (see FIG. 6) in the vertical direction. In this preferred embodiment, the block body 51 is fixed to a front end 63 of the elongated projection 61 through two screws 64, is formed with two lugs 52 projecting outwardly from two opposite sides of the block body 51 and secured to the rear face 42 of the nose plate 40. The block body 51 has a front end opposite to the front end 63 of the projection 61, and extending into the rectangular portion 450 of the nail-discharging opening 45 in the nose plate 40 to define an inverted U-shaped nail passage 51″ (see FIG. 8). Under this condition, the inverted U-shaped portion (715P) of the nail-receiving channel 715 is aligned with and is in spatial communication with the inverted U-shaped nail passage 51″ (see FIG. 8) and the straight branch portion 716 of the nail-receiving channel 715 of the nail-holding member 70 is aligned with and is in spatial communication with the straight branch portion 451 of the nail-discharging opening 45 in the nose plate 40. The nail-receiving channel 715 of the nail-holding member 70 is adapted to receive a plurality of elongated nails 90 or a plurality of U-shaped nails 91 therein (see FIGS. 6 and 7). Each nail 90 includes an elongated shank 902 and an enlarged head 901 fixed to the shank 902, and is received in the straight branch portion 716 and the first segment 715″ of the nail-receiving channel 715 (see FIG. 6). The nail 90 has a length from 14 to 30 mm. Each nail 91 is received in the inverted U-shaped portion (715P) of the nail-receiving channel 715, and has a bight section 911 and opposing first and second section 912 extending downwardly and respectively from two opposite ends of the bight section 911 in the vertical direction. The urging member 72 is disposed in the nail-holding member 70 to urge a respective one of the nails 90, 91 into the nail-impelling track 47 in the nose plate 40 (see FIG. 8) through the nail passage 51″.

Referring to FIG. 8, when a small-size inverted U-shaped nail 91 is used in the cartridge of the present invention, since the distal ends of left and right portions 912 of the nail 91 are located adjacent to the discharging end 43 of the nose plate 41, the driving force of the nail 91 will not be affected adversely during the nailing operation.

With this invention thus explained, it is apparent that numerous modifications and variations can be made without departing from the scope and spirit of this invention. It is therefore intended that this invention be limited only as indicated in the appended claims.

We claim:

1. A cartridge for a nail driving device having a barrel and a plunger, comprising:
a nose plate adapted to be connected to the barrel, extending in a vertical direction, having opposite front and rear faces and a discharging end distal from the barrel, and formed with a nail-discharging opening that is disposed adjacent to said discharging end and that extends through said front and rear faces, and a nail-impelling track that extends in said vertical direction, that is in spatial communication with said nail-discharging opening and that is adapted to receive the plunger; and
a nail-holding member including
a stationary part that is disposed rearwardly of and that is secured to said nose plate, that extends in a transverse direction relative to said nose plate, and that has a front end, and
a slidable part that extends rearwardly from said rear face of said nose plate in said transverse direction, and that is slidable in said transverse direction, said slidable part having a peripheral wall that has opposite front and rear ends and that confines an inner space therein, said inner space extending from said front end to said rear end in said transverse direction, said slidable part being mounted slidably on said stationary part;
wherein said stationary part is received in said inner space to cooperate with said peripheral wall of said slidable part to define a nail-receiving channel therebetween, said front end of said stationary part extending outwardly of said inner space into said nail-discharging opening in said nose plate, said nail-receiving channel being in spatial communication with said nail-discharging opening, extending rearwardly from said nail-discharging opening in said transverse direction, and being adapted to receive nails therein, said nail-receiving channel having an inverted U-shaped portion and a straight branch portion, said inverted U-shaped portion having a bight segment and opposing first and second segments extending downwardly and respectively from two opposite ends of said bight segment in said vertical direction, said straight branch portion extending upwardly from one of said opposite ends of said bight segment in said vertical direction.

2. The cartridge as defined in claim 1, wherein said nose plate has a coupling end opposite to said discharging end and adapted to be connected to the barrel of the nail driving device.

3. The cartridge as defined in claim 1, wherein said stationary part includes an elongated base extending in said transverse direction, an elongated projection that is disposed between two opposite sides of said base and that projects upwardly from said base, and two elongated rails projecting upwardly from said opposite sides of said base, said peripheral wall having two elongated side wall portions that respectively define two rail-receiving grooves that are in spatial communication with said inner space, said rails of said stationary part being respectively received in said rail-receiving grooves, said projection being received in said inner space and cooperating with said peripheral wall of said slidable part to define said nail-receiving channel.

4. The cartridge as defined in claim 3, wherein said projection has a front end, said stationary part further including a block body that is fixed to said front end of said projection, that is formed with two lugs projecting outwardly from two opposite sides of said block body and secured to said rear face of said nose plate, and that has a front end, said nail-discharging opening in said nose plate having a rectangular portion adjacent to said discharging end of said nose plate and a straight branch portion extending upwardly from said rectangular portion in said vertical direction and being aligned with and being in spatial communication with said straight branch portion of said nail-receiving channel, said front end of said block body extending into said rectangular portion of said nail-discharging opening in said nose plate to define an inverted U-shaped nail passage therebetween, said nail passage being aligned with and being in spatial communication with said inverted U-shaped portion of said nail-receiving channel, said front end of said block body defining said front end of said stationary part.
